(19) United States
(12) Patent Application Publication
(10) Pub. No.: US 2015/0101031 A1
(43) Pub. Date: Apr. 9, 2015

(54) VERIFICATION THAT AN AUTHENTICATED USER IS IN PHYSICAL POSSESSION OF A CLIENT DEVICE

(71) Applicant: DEVICEAUTHORITY, INC., Fremont, CA (US)

(72) Inventors: Dono Harjanto, Irvine, CA (US); Talbot HARTY, Sutter Creek, CA (US); Prakash CHANDRA, Fremont, CA (US); Antonius HADIPUTRA, Rohnert Park, CA (US)

(73) Assignee: DEVICEAUTHORITY, INC., Fremont, CA (US)

(21) Appl. No.: 14/507,631

(22) Filed: Oct. 6, 2014

Related U.S. Application Data
(60) Provisional application No. 61/886,813, filed on Oct. 4, 2013.

(51) Int. Cl. H04L 29/06; H04L 12/26; G06F 3/01

(52) U.S. Cl. CPC H04L 63/08; G06F 3/017; H04L 43/08
USPC 726/7

(57) ABSTRACT

A device user being authenticated is determined to be in physical possession of the device according to data in one or more user input device buffers that indicates whether data received from a user input device is injected or is generated by physical manipulation of the user input device. If the events recorded in the buffer are not injected, the user entering the authentication data is determined to be in physical possession of the device and the user can be authenticated if the authentication data entered by the user matches predetermined reference data. Conversely, if the events are injected, the user is determined to not be in physical possession of the device and authentication fails regardless of whether the authentication data matches the predetermined reference data.

This application claims priority to U.S. Provisional Application No. 61/886,813, which was filed Oct. 4, 2013 and which is fully incorporated herein by reference.

### BACKGROUND OF THE INVENTION

1. Field of the Invention

The present invention relates generally to network-based computer security and, more particularly, methods of and systems for authenticating a user of a device for computer network security.

2. Description of the Related Art

In some computer attacks, a device can be controlled by a person who is physically remote from the device. In such attacks, that person can use any of a number of Remote Desktop Protocols (RDPs) to control the device, even without having physical possession of the device. The attacking person may gain access to passwords and other authentication data stored on the device such that the person can spoof authentication of the legitimate user of the device and obtain services through the Internet that should not be authorized.

What is needed is a way to determine whether a person providing authentication data is in physical possession of the device carrying out the authentication session.

### SUMMARY OF THE INVENTION

In accordance with the present invention, a device user being authenticated is determined to be in physical possession of the device according to data in one or more user input device buffers that indicates whether data received from a user input device is injected or is generated by physical manipulation of the user input device. An authentication server monitors buffers of one or more user input devices that are expected to be used by the user during a user input event (such as a logon attempt) in which authentication data is input by the user. The buffers include data representing events of the user input devices and include injected flags for each event to indicate whether the event is responsive to physical manipulation of the user input device or is injected by logic executing in the device, such as logic implementing RDP for example. In one embodiment, the authentication server prompts the user to enter data for the input event.

If the events recorded in the buffer are not injected but are instead responsive to physical manipulation of the user input device, the user entering the authentication data is determined to be in physical possession of the device and authentication proceeds. The user can be authenticated if the authentication data entered by the user matches predetermined reference data. Conversely, if the events are injected, the user is determined not to be in physical possession of the device and authentication fails regardless of whether the authentication data matches the predetermined reference data.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a computing device, a server, and an authentication server that cooperate to identify and authenticate the user of the device in accordance with one embodiment of the present invention.

FIG. 2 is a logic flow diagram illustrating the extraction of user-generated data and buffer data representing whether the user-generated data is injected.

FIG. 3 is a logic flow diagram illustrating the determination of whether the user-generated data is injected.

FIG. 4 is a block diagram of an input buffer record to be used to determine whether the user-generated data is injected.

FIG. 5 is a block diagram of a user response record, including the user-generated data and data indicating whether the user-generated data is injected, to be used for authentication of the device of FIG. 1 and its user.

FIG. 6 is a transaction flow diagram illustrating the manner in which the device, the server, and the authentication server of FIG. 1 cooperate to authenticate the device and its user.

FIG. 7 is a block diagram of a known device record used by the authentication server to authenticate the device and its user.

FIG. 8 is a logic flow diagram of an authentication process by which the authentication server authenticates the device and its user.

FIG. 9 is a block diagram showing in greater detail the server of FIG. 1.

FIG. 10 is a block diagram showing in greater detail the authentication server of FIG. 1.

FIG. 11 is a block diagram showing in greater detail the device of FIG. 1.

### DETAILED DESCRIPTION

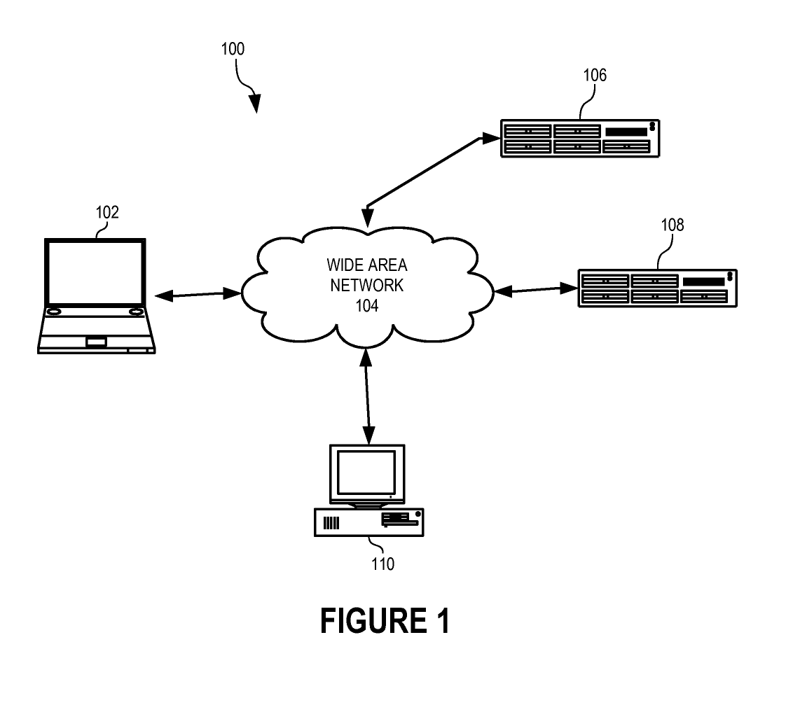

In accordance with the present invention, an authentication server 108 (FIG. 1) authenticates a user of a device 102 using user input device buffer data representing whether user-generated data is injected while the user performs a predetermined or expected gesture with device 102.

As used herein, the term gesture refers to an act of physical manipulation of a device 102 by a user in physical possession of that device that triggers an input signal distinguishable from an input signal that is injectable by a remote device or a local process. Examples of such input signals triggered by such a gesture are low-level input signals generated by keystrokes on a conventional keyboard or mouse. Further examples of gestures include physical movement or reorientation of a mobile or hand-held device that generates input signals from accelerometers installed on the device. It is contemplated that other types of gestures may fall within the scope of this definition, such as voice input or other physical movements of a user that cause low-level input signals distinguishable from an input signal that is injectable by a remote device or by another process such as malware.

To facilitate appreciation and understanding of the present invention, user device buffers are briefly described. User input devices such as keyboards and mice communicate with a computing device asynchronously, meaning that the device does not know when to expect signals from such user input devices. User input devices detect physical manipulation by a human user and generate signals that represent the detected physical manipulation. For example, when a user presses the “x” key on a keyboard, the keyboard detects the pressing and, in response, generates data indicating that the “x” key has been pressed and sends the data to the computing device.

Since the keyboard sends data asynchronously, the computing device has a buffer, i.e., a portion of memory, set aside to receive user input data when the computing device might be busy doing other things. Remote Desktop Protocols (RDPs) and other logic can mimic physical manipulation of user input devices by injecting, i.e., writing, data into user input device buffers. The computing device processes the injected data as it would data received from a user input device. Such allows for such things as RDPs and macros and other simulated use of the computing device, and such injection data is typically effected at the application level.

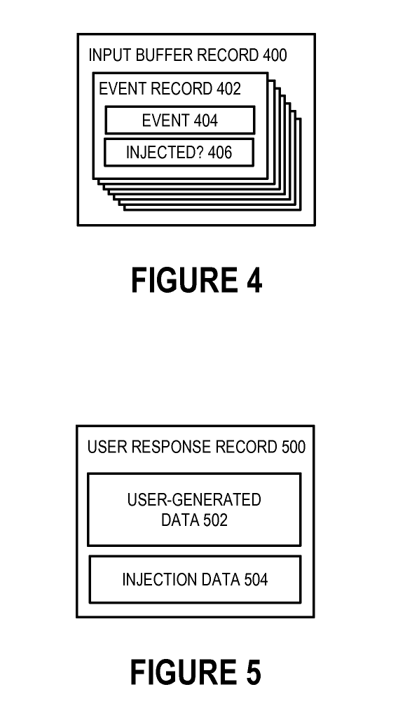

Data stored in user input device buffers are generally of the structure shown as input buffer record 400 (FIG. 4). Input buffer record 400 includes a number of event records 402, each of which includes an event 404 and an injected flag 406. Event 404 represents the particular user input device physical manipulation that was detected. In the case of keyboard events, examples include the pressing or releasing of a key and whether the key is pressed in combination with other keys. In the case of mouse events, examples of events include the movement of the mouse to a particular location and the pressing or releasing of a mouse button. Events can be of higher levels of abstraction as well. For example, mouse events can include movement of a cursor over, or clicking of, a graphical user interface (GUI) element such as a GUI button. In the case of accelerometer events, data indicating the movement or positional change of a mobile device in three-dimensional space may be stored in memory not simulatable by injected signaling.

Injected flag 406 specifies whether event 404 was injected by logic executing within the computing device, e.g., device 102 (FIG. 1), or received from a user input device of device 102. Accordingly, injected flag 406 (FIG. 4) indicates whether event 404 represents physical manipulation of a user input device of device 102 (FIG. 1) by a local human user or data injected by logic executing in device 102 and perhaps originating from a remotely located device such as device 110.

Authentication system 100 (FIG. 1) includes device 102, a server 106, and authentication server 108 that are connected to one another through a wide area computer network 104, which is the Internet in this illustrative embodiment. Device 102 can be any of a number of types of networked computing devices, including smart phones, tablets, netbook computers, laptop computers, and desktop computers. Server 106 is a server that provides services to remotely located devices such as device 102 but that is configured to require authentication of the user of device 102 prior to providing those services. Authentication server 108 is a server that authenticates devices and users of such devices, sometimes on behalf of other computers such as server 106. In this embodiment, authentication server 108 is tasked with verifying that authentication of device 102 is performed by a user in physical possession of device 102 and not someone controlling device 102 from another device, such as device 110.

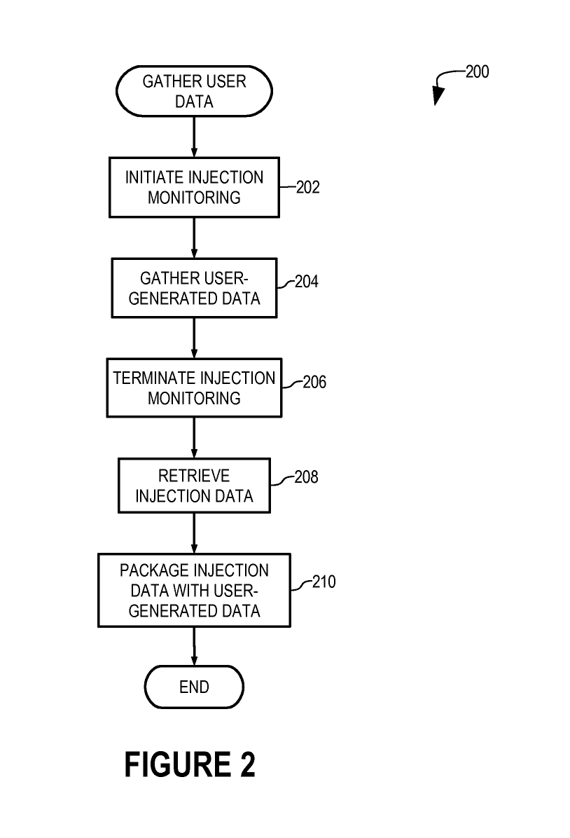

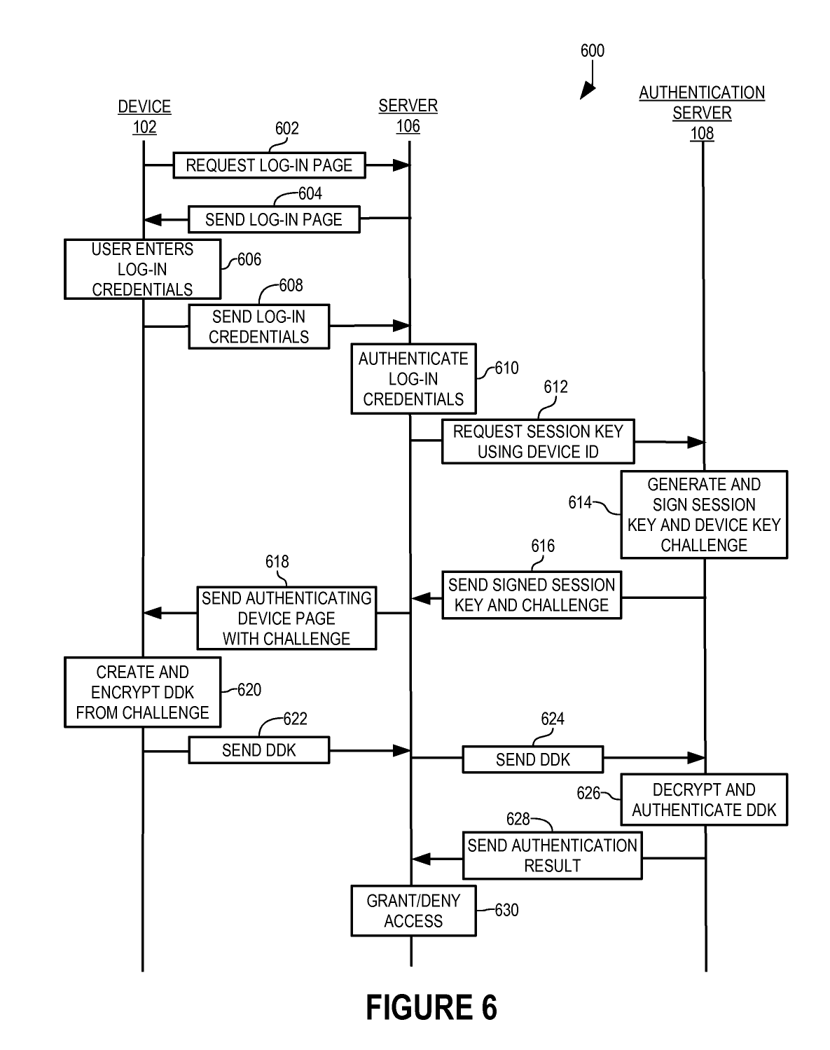

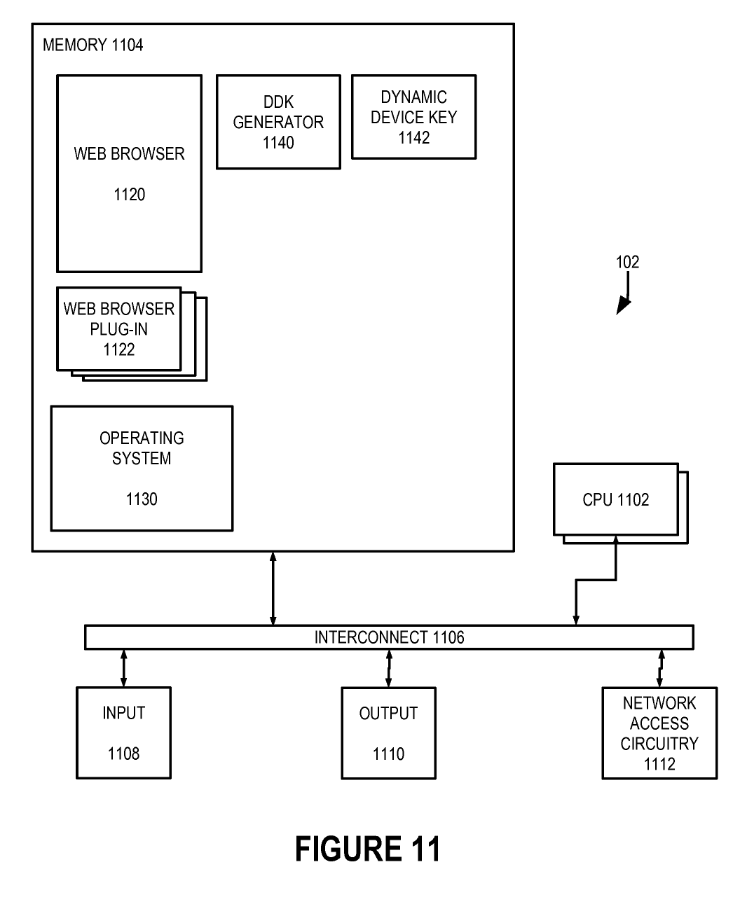

In an authentication transaction that is described below in greater detail in conjunction with transaction flow diagram 600 (FIG. 6), device 102 (FIG. 1) receives authentication logic from server 106 and/or authentication server 108 that causes device 102 to gather authentication data in the manner illustrated by logic flow diagram 200 (FIG. 2). In step 202, the authentication logic causes logic within device 102, such as DDK generator 1140 (FIG. 11) described below, to begin monitoring user input device buffers.

In step 204, the authentication logic gathers data generated by the user. In one embodiment, the data is gathered responsive to a prompt from the authentication server 108. For example, if the authentication requires the user to enter credentials such as a username and passphrase, the authentication logic prompts the user to enter the username and passphrase and receives data entered by the user in response to the prompt in step 204. In another embodiment, the prompt may require that the user physically reposition a mobile device 102, e.g., by rotating the device 90 degrees, by changing its position to a portrait or landscape orientation, or by rotating the device some number of degrees about any one of the conventional orthogonal axes. In another embodiment, no prompting is required in step 204, and instead step 204 represents a monitoring action initiated by the authentication server. That is, authentication logic is programmed to expect gesture-induced input from device 102 if in fact the user requesting device registration is in physical possession of the device. If so, the expected gesture-induced input will cause data representing, e.g. keystrokes or accelerometer signals, to be transmitted in a subsequent step.

In step 206, the authentication logic terminates the monitoring of user input device buffers, e.g, by DDK generator 1140 (FIG. 11). In step 208 (FIG. 2), the authentication logic retrieves data representing whether the user-generated data gathered in step 204 was injected. In this illustrative embodiment, during process 200, DDK generator 1140 (FIG. 11) monitors user input device buffers during a period of time requested by the authentication logic, collects data representing injection flags of the events added to the user input device buffers during that period of time, and provides the data representing the injection flags to the authentication logic.

In step 210 (FIG. 2), the authentication logic packages the injection data with the user-generated data to make the packaged data tamper-evident and perhaps to encrypt the packaged data as well. An example of such packaged data is user response record 500 (FIG. 5), which includes user-generated data 502 and injection data 504. In this illustrative embodiment, injection data 504 has the structure of input buffer record 400 (FIG. 4) and includes all user input device buffer events captured by DDK generator 1140 (FIG. 11).

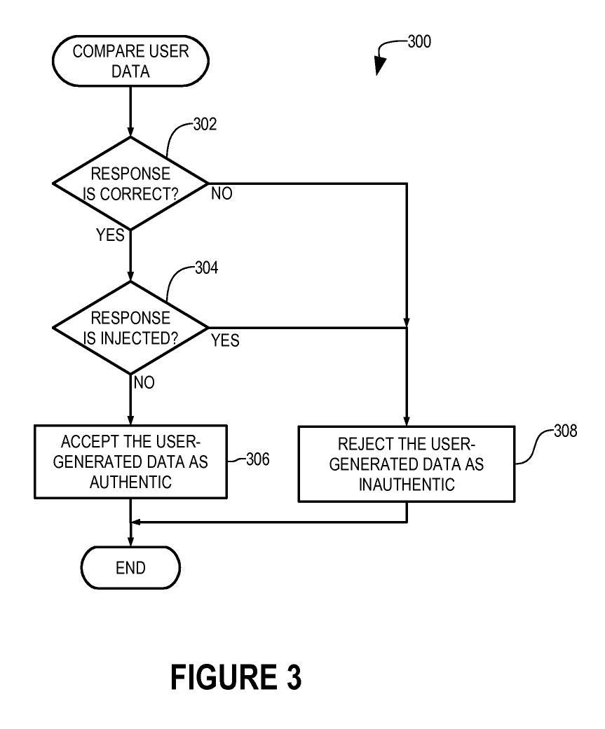

The user-generated authentication data is evaluated, e.g., by server 106 (FIG. 1) or authentication server 108, in a manner illustrated by logic flow diagram 300 (FIG. 3). Logic flow diagram 300 is described in the illustrative example of being performed by authentication server 108. In addition, logic flow diagram 300 is performed after the packaged user-generated data and injection data have been unpacked and determined to not have been tampered with.

In test step 302, authentication server 108 determines whether the user-generated data is correct, i.e., matches predetermined reference data. For example, if the user-generated data represents a username and an associated passphrase, authentication server 108 stores predetermined reference data that includes username and associated passphrase pairs. If the user-generated data matches any of the username-and-passphrase pairs, authentication server 108 determines that the user-generated data is correct in test step 302.

If the user-generated data is not correct, processing by authentication server 108 transfers to step 308 in which authentication server rejects the user-generated data as inauthentic. Conversely, if the user-generated data is correct, processing by authentication server 108 transfers to test step 304.

In test step 304, authentication server 108 determines whether the user-generated data was injected rather than entered by a human user in physical possession of device 102. There are a number of ways authentication server 108 can evaluate the injection data to determine whether the user-generated data had been injected. In one embodiment, authentication server 108 determines that the user-generated data had been injected if any events of the monitored user input device buffer had been injected. In another embodiment, authentication server 108 determines that the user-generated data had been injected only if all events of the monitored user input device buffer had been injected. In a variation of these embodiments, authentication server 108 identifies specific events in the injection data that correlate to generation of the user-generated data and consider only those events in determining whether the user-generated data had been injected. In another embodiment, in step 304 the authentication server 108 determines whether any gesture-induced low-level input data was received concurrently with the user-generated data, i.e. within a predetermined time period associated with receipt of the user-generated data. In this embodiment, the actual content of the low-level input data need not be tested; its mere presence can be sufficient evidence that a user is in physical possession of the device 102. In more elaborate embodiments, some or all of the content of the low-level input may be verified by comparison to expected user-generated data. In either case, receipt of expected gesture-induced input signals allows the authentication server to determine that the user-generated data is not injected data.

If authentication server 108 determines in test step 304 that the user-generated data had been injected, processing transfers to step 308 in which authentication server 108 rejects the user-generated data as inauthentic. Conversely, if authentication server 108 determines in test step 304 that the user-generated data had not been injected, processing transfers to step 306 in which authentication server 108 accepts the user-generated data as authentic.

Transaction flow diagram 600 (FIG. 6) illustrates the use of authentication server 108 to authenticate device 102 and its user with server 106. This authentication is based on device attributes stored in registration records for each registered device, so such device attributes are discussed to facilitate appreciation and understanding of logic flow diagram 600 (FIG. 6).

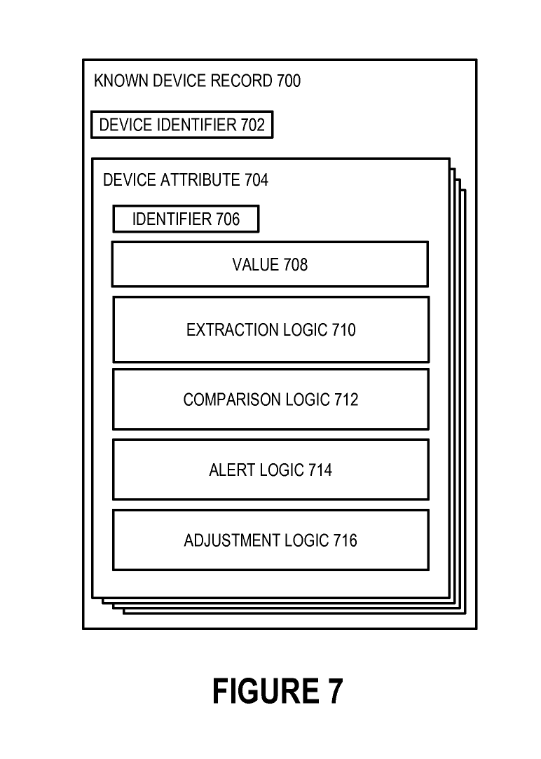

In this illustrative embodiment, the user-generated data and injection data are combined with other attributes of device 102 and of the user of device 102 to form a dynamic device key (DDK) of device 102. Such other attributes include hardware and system configuration attributes of device 102 that make up an internal state of device 102. Known device record 700 (FIG. 7) includes a device identifier 702 that identifies device 102 and device attributes 704. Each device attribute 704 includes an identifier 706 and a value 708. Examples of device attributes of device 102 include a serial number of a storage device within device 102 and detailed version information regarding an operating system executing within device 102. In the example of a serial number of a storage device, identifier 706 specifies the serial number of a given storage device (such as “C:” or “/dev/sdal”) as the particular information to be stored as value 708, and value 708 stores the serial number of the given storage device of device 102.

Device attributes 704 that are used to authenticate the user of device 102 are sometimes referred to as interactive device attributes. At least one of device attributes 704 is an interactive attribute that requires the user of device 102 to take some action.

Device attribute 704 also includes extraction logic 710, comparison logic 712, alert logic 714, and adjustment logic 716. The particular device attribute represented by device attribute 704 is sometimes referred to as “the subject device attribute” in the context of FIG. 7.

Extraction logic 710 specifies the manner in which the subject device attribute is extracted by device 102. Logic flow diagram 200 (FIG. 2) is an example of extraction logic 710.

Comparison logic 712 specifies the manner in which the subject device attribute is compared to a corresponding device attribute to determine whether device attributes match one another. Logic flow diagram 300 (FIG. 3) is an example of comparison logic 712.

Alert logic 714 can specify alerts of device matches or mismatches or other events. Examples of alert logic 714 include e-mail, SMS messages, and such to the owner of device 102 and/or to a system administrator responsible for proper functioning of device 102.

Adjustment logic 716 specifies the manner in which the subject device attribute is to be adjusted after authentication. For example, if the action to be performed by the user in an interactive device attribute changes over time, adjustment logic 716 can cause value 708 to be updated accordingly.

Device attribute 704 is shown to include the elements previously described for ease of description and illustration. However, it should be appreciated that a device attribute 704 for a given device can include only identifier 706 and value 708, while a separate device attribute specification can include extraction logic 710, comparison logic 712, alert logic 714, and adjustment logic 716. In addition, all or part of extraction logic 710, comparison logic 712, alert logic 714, and adjustment logic 716 can be common to attributes of a given type and can therefore be defined for the given type.

Returning to transaction flow diagram 600 (FIG. 6), device 102 sends a request in step 602 for a log-in web page to server 106 by which the user of device 102 can authenticate herself. The request can be in the form of a URL specified by the user of device 102 using web browser 1120 (FIG. 11) and conventional user interface techniques involving physical manipulation of user input devices 1108.

In step 604 (FIG. 6), server 106 sends the web page that is identified by the request received in step 602. In this illustrative example, the web page sent to device 102 includes content that defines a user interface by which the user of device 102 can enter her authentication credentials, such as a user name and associated password for example. In addition, the web page can include authentication logic that gathers data entered by the user in the manner described above with respect to logic flow diagram 200 (FIG. 2). Alternatively, server 106 can use conventional authentication techniques, leaving enhanced user authentication in the manner described above in conjunction with FIGS. 2 and 3 to authentication server 108.

In step 606 (FIG. 6), web browser 1120 (FIG. 11) of device 102 executes the user interface and the authentication logic if present, and the user of device 102 enters her authentication credentials, e.g., by conventional user interface techniques involving physical manipulation of user input devices 1108.

In step 608 (FIG. 6), device 102 sends the entered authentication credentials to server 106. In this illustrative embodiment, device 102 also sends an identifier of itself along with the authentication credentials. Server 106 authenticates the authentication credentials in step 610, e.g., by comparison to previously registered credentials of known users. As noted above with respect to step 604, server 106 can authenticate the user in the manner described above with respect to logic flow diagram 300 (FIG. 3) or can leave such authentication to authentication server 108. If the credentials are not authenticated, processing according to transaction flow diagram 600 terminates and the user of device 102 is denied access to services provided by server 106. Conversely, if server 106 determines that the received credentials are authentic, processing according to transaction flow diagram 600 continues.

In step 612 (FIG. 6), server 106 sends a request to authentication server 108 for a session key using the device identifier received with the authentication credentials.

In response to the request, authentication server 108 generates and cryptographically signs a session key. Session keys and their generation are known and are not described herein. In addition, authentication server 108 creates a device key challenge and encrypts the device key challenge using a public key of device 102 and PKI.

To create the device key challenge, authentication server 108 retrieves the known device record 700 (FIG. 7) representing device 102 using the received device identifier and comparing it to device identifier 702. The device key challenge specifies all or part of one or more of device attributes 704 to be included in the device key and is described in greater detail below.

In step 616 (FIG. 6), authentication server 108 sends the signed session key and the encrypted device key challenge to server 106.

In step 618, server 106 sends an “authenticating” page to device 102 along with the device key challenge. The “authenticating” page includes content that provides a message to the user of device 102 that authentication of device 102 and its user is underway and content that causes device 102 to produce a dynamic device key in the manner specified by the device key challenge.

The device key challenge causes web browser 1120 (FIG. 11) of device 102 to generate a device identifier, sometimes referred to herein as a dynamic device key (DDK) for device 102, e.g., dynamic device key 1142. In one embodiment, a web browser plug-in 1122 is installed in client device 102 and, invoked by web browser 1120, processes the content of the web page to generate the DDK. In other embodiments, DDK 1142 of device 102 can be generated by other forms of logic of device 102, such as DDK generator 1140, which is a software application installed in device 102.

The device key challenge specifies the manner in which DDK 1142 is to be generated from the attributes of device 102 represented in device attributes 704 (FIG. 7). The challenge specifies a randomized sampling of attributes of device 102, allowing the resulting DDK 1142 to change each time device 102 is authenticated. There are a few advantages to having DDK 1142 represent different samplings of the attributes of device 102. One is that any data captured in a prior authentication of device 102 cannot be used to spoof authentication of device 102 using a different device when the challenge has changed. Another is that, since only a small portion of the attributes of device 102 are used for authentication at any time, the full set of attributes of device 102 cannot be determined from one, a few, several, or even many authentications of device 102.

The device key challenge specifies items of information to be collected from hardware and system configuration attributes of device 102 and the manner in which those items of information are to be combined to form DDK 1142. In this embodiment, the challenge specifies that the user enter data that is gathered in the manner described above with respect to logic flow diagram 200 (FIG. 2) to provide user-generated data corresponding to an interactive device attribute.

In step 620 (FIG. 3), device 102 gathers user-generated data for inclusion in the DDK according to the device key challenge in the manner described above with respect to logic flow diagram 200 (FIG. 2). If present, low-level gesture-induced data is embedded into the DDK. To provide greater security, DDK 1142 includes data representing the user-generated data obfuscated using a nonce included in the challenge.

Once DDK 1142 (FIG. 11) is generated according to the received device key challenge, device 102 encrypts DDK 1142 using a public key of authentication server 108 and PKI.

In step 622 (FIG. 6), device 102 sends the encrypted dynamic device key to server 106, and server 106 sends the encrypted dynamic device key to authentication server 108 in step 624.

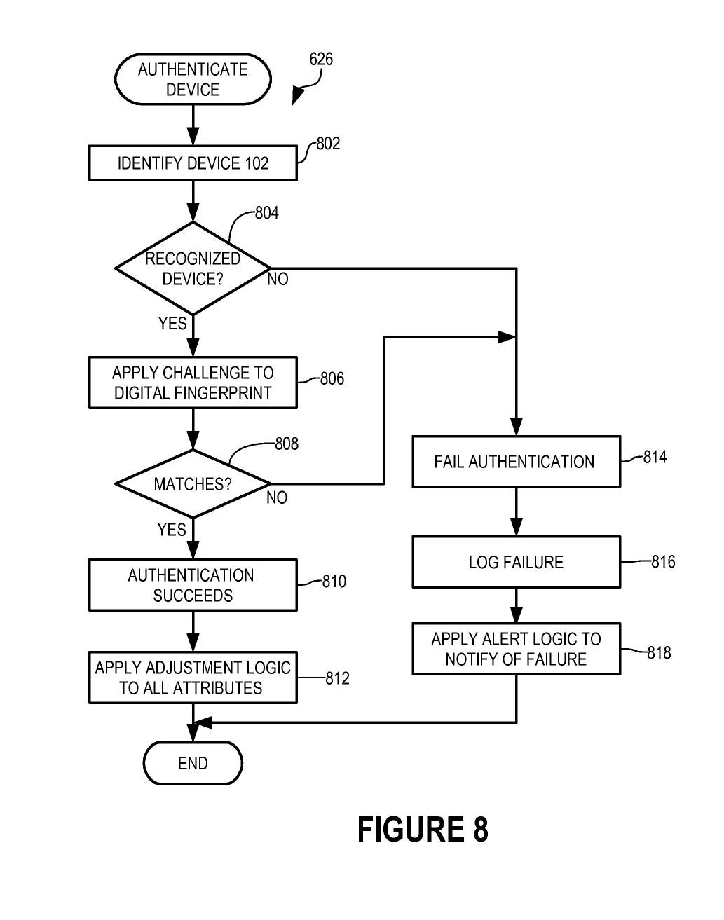

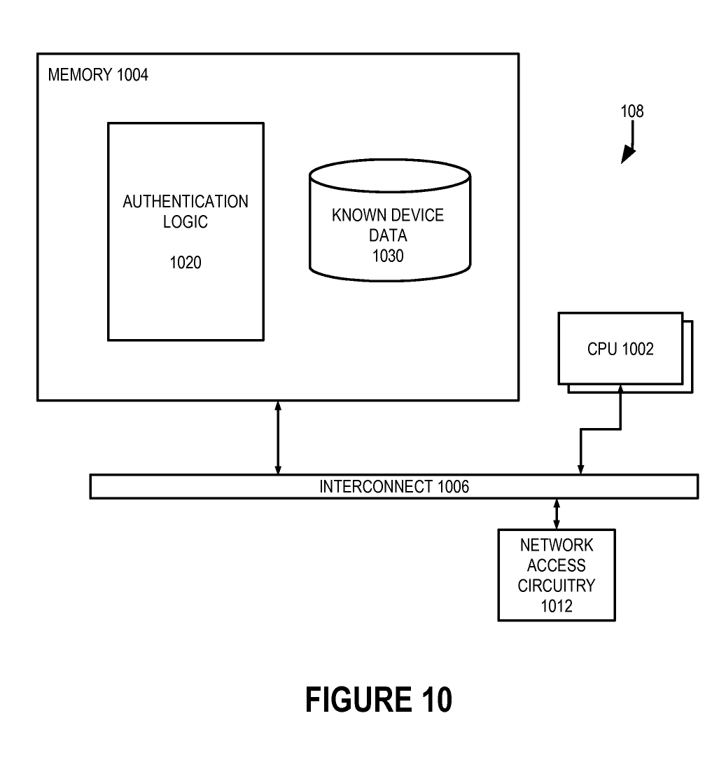

In step 626, authentication logic 1020 (FIG. 10) of authentication server 108 decrypts and authenticates the received DDK. Step 626 is shown in greater detail as logic flow diagram 626 (FIG. 8).

In step 802, authentication logic 1020 identifies device 102. In this illustrative embodiment, the received DDK includes a device identifier corresponding to device identifier 702 (FIG. 7). Authentication logic 1020 identifies device 102 by locating a known device record 700 in which device identifier 702 matches the device identifier of the received DDK.

In test step 804 (FIG. 8), authentication logic 1020 determines whether device 102 is identified. In particular, authentication logic 1020 determines whether a known device record with a device identifier matching the device identifier of the received DDK is successfully found in known device data 1030 (FIG. 10). If so, processing transfers to step 806. Otherwise, processing transfers to step 814, which is described below.

In step 806, authentication logic 1020 applies the same device key challenge sent in step 616 (FIG. 6) to the known device record 700 (FIG. 5) that corresponds to the identified device. In this illustrative embodiment, the device key challenge produces a DDK in which a portion of the DDK generated from non-interactive attributes can be parsed from a portion generated from interactive attributes, i.e., attributes that require response from the user of device 102, such that device 102 can be authenticated separately from the user of device 102.

In test step 808 (FIG. 8), authentication logic 1020 determines whether the received DDK authenticates device 102 and its user by comparing the resulting DDK of step 806 to the received DDK. In this illustrative embodiment, authentication logic 1020 uses comparison logic 712 (FIG. 7) for each of the device attributes 704 included in the device key challenge. For attributes in which the user is to enter gesture-induced data by physical manipulation of user input devices 1108 (FIG. 11), comparison logic 712 (FIG. 7) in this illustrative embodiment specifies that the user-generated data represented in the received DDK is compared to the predetermined reference data of value 708 and that the user-generated data was not injected in the manner described above with respect to logic flow diagram 300 (FIG. 3). Alternatively, comparison logic 712 merely checks for the presence of low-level gesture-induced input to verify that the user-generated data was not injected at the application level.

If the received DDK does not authenticate device 102, processing transfers to step 814 (FIG. 8) and authentication fails or, alternatively, to step 614 (FIG. 6) in which authentication logic 1020 sends another device key challenge to re-attempt authentication. If the received DDK authenticates device 102, processing transfers to step 810 (FIG. 8).

In step 810, authentication logic 1020 determines that device 102 is successfully authenticated.

In step 812 (FIG. 8), authentication logic 1020 applies adjustment logic 716 (FIG. 7) of each of device attributes 704 uses to generate the received DDK. After step 812 (FIG. 8), processing according to logic flow diagram 626, and therefore step 626 (FIG. 6), completes. As described above, authentication failure at either of test steps 804 (FIG. 8) and 808 transfers processing to step 814.

In step 814, authentication logic 1020 determines that device 102 or its user is not authentic, i.e., that authentication according to logic flow diagram 626 fails.

In step 816, authentication logic 1020 logs the failed authentication and, in step 818, applies alert logic 714 (FIG. 7) to notify various entities of the failed authentication. After step 818 (FIG. 8), processing according to logic flow diagram 626, and therefore step 626 (FIG. 6), completes.

In step 628 (FIG. 6), authentication server 108 sends data representing the result of authentication of device 102 to server 106.

In step 630, server 106 determines whether to continue to interact with device 102 and in what manner according to the authentication results received in step 628.

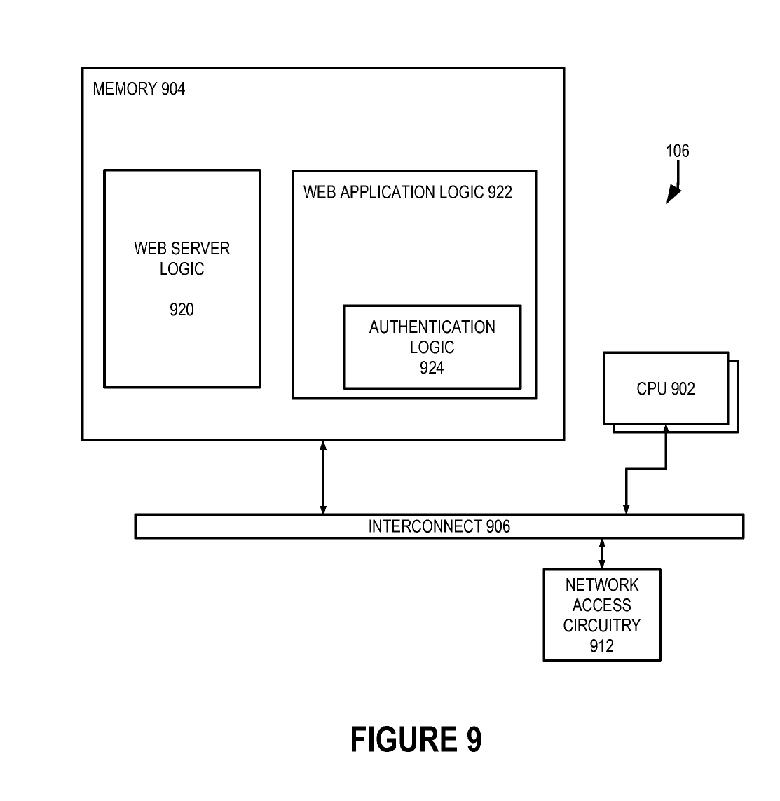

Server computer 106 is shown in greater detail in FIG. 9. Server 106 includes one or more microprocessors 902 (collectively referred to as CPU 902) that retrieve data and/or instructions from memory 904 and execute retrieved instructions in a conventional manner. Memory 904 can include generally any computer-readable medium including, for example, persistent memory such as magnetic and/or optical disks, ROM, and PROM and volatile memory such as RAM.

CPU 902 and memory 904 are connected to one another through a conventional interconnect 906, which is a bus in this illustrative embodiment and which connects CPU 902 and memory 904 to network access circuitry 912. Network access circuitry 912 sends and receives data through computer networks such as wide area network 104 (FIG. 1).

A number of components of server 106 are stored in memory 904. In particular, web server logic 920 and web application logic 922, including authentication logic 924, are all or part of one or more computer processes executing within CPU 902 from memory 904 in this illustrative embodiment but can also be implemented using digital logic circuitry.

Web server logic 920 is a conventional web server. Web application logic 922 is content that defines one or more pages of a web site and is served by web server logic 920 to client devices such as device 102. Authentication logic 924 is a part of web application logic 922 that causes client devices and their users to authenticate themselves in the manner described above.

Authentication server 108 is shown in greater detail in FIG. 10. Authentication server 108 includes one or more microprocessors 1002 (collectively referred to as CPU 1002), memory 1004, a conventional interconnect 1006, and network access circuitry 1012, which are directly analogous to CPU 902 (FIG. 9), memory 904, conventional interconnect 906, and network access circuitry 912, respectively.

A number of components of authentication server 108 (FIG. 10) are stored in memory 1004. In particular, authentication logic 1020 is all or part of one or more computer processes executing within CPU 1002 from memory 1004 in this illustrative embodiment but can also be implemented using digital logic circuitry. Known device data 1030 is data stored persistently in memory 1004 and includes a known device records such as known device record 700 (FIG. 7). In this illustrative embodiment, known device data 1030 (FIG. 10) is organized as all or part of one or more databases.

Device 102 is a personal computing device and is shown in greater detail in FIG. 11. Device 102 includes one or more microprocessors 1102 (collectively referred to as CPU 1102) that retrieve data and/or instructions from memory 1104 and execute retrieved instructions in a conventional manner. Memory 1104 can include generally any computer-readable medium including, for example, persistent memory such as magnetic and/or optical disks, ROM, and PROM and volatile memory such as RAM.

CPU 1102 and memory 1104 are connected to one another through a conventional interconnect 1106, which is a bus in this illustrative embodiment and which connects CPU 1102 and memory 1104 to one or more input devices 1108, output devices 1110, and network access circuitry 1112. Input devices 1108 can include, for example, a keyboard, a keypad, a touch-sensitive screen, a mouse, a microphone, and one or more cameras. Output devices 1110 can include, for example, a display—such as a liquid crystal display (LCD)—and one or more loudspeakers. Network access circuitry 1112 sends and receives data through computer networks such as wide area network 104 (FIG. 1).

A number of components of device 102 are stored in memory 1104. In particular, web browser 1120 is all or part of one or more computer processes executing within CPU 1102 from memory 1104 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 1122 are each all or part of one or more computer processes that cooperate with web browser 1120 to augment the behavior of web browser 1120. The manner in which behavior of a web browser is augmented by web browser plug-ins is conventional and known and is not described herein.

Operating system 1130 is all or part of one or more computer processes executing within CPU 1102 from memory 1104 in this illustrative embodiment but can also be implemented using digital logic circuitry. An operating system (OS) is a set of programs that manage computer hardware resources and provide common services for application software such as web browser 1120, web browser plug-ins 1122, and DDK generator 1140.

DDK generator 1140 is all or part of one or more computer processes executing within CPU 1102 from memory 1104 in this illustrative embodiment but can also be implemented using digital logic circuitry. DDK generator 1140 facilitates authentication of device 102 in the manner described above.

Dynamic device key 1142 is data stored persistently in memory 1104.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for determining that a person is in physical possession of a remotely located device, the method comprising:
monitoring the remotely located device for gesture-induced data associated with physical manipulation of at least one user input device of the remotely located device;
causing the remotely located device to record buffer data representing one or more events of the user input device;
causing the remotely located device to record user-generated data received from the user input device;
determining whether the buffer data indicates that the user-generated data is generated in response to physical manipulation by the user; and
determining that the user is in physical possession of the remotely located device upon determining that the buffer data indicates an absence of injected data.

2. The method of claim 1 wherein the at least one user input device of the remotely located device includes a keyboard; and
further wherein the one or more events of the user input device include pressing of one or more keys on the keyboard.

3. The method of claim 1 further comprising:
determining that the user is in not physical possession of the remotely located device upon determining that the buffer data indicates that the at least some of the events of the user input device are not generated in response to physical manipulation by the user.

4. The method of claim 1 further comprising:
comparing the user-generated data to predetermined reference data.

5. The method of claim 4 further comprising:
authenticating the user of the remotely located device only upon a condition in which (i) the user-generated data matches the predetermined reference data and (ii) the user is determined to be in physical possession of the remotely located device.

6. A tangible computer readable medium useful in association with a computer that includes one or more processors and a memory, the computer readable medium including computer instructions that are configured to cause the computer, by execution of the computer instructions in the one or more processors from the memory, to determine that a person is in physical possession of a remotely located device by at least:
monitoring the remotely located device for gesture-induced data associated with physical manipulation of at least one user input device of the remotely located device;
causing the remotely located device to record buffer data representing one or more events of the user input device;
causing the remotely located device to record user-generated data received from the user input device;
determining whether the buffer data indicates that the user-generated data is generated in response to physical manipulation by the user; and
determining that the user is in physical possession of the remotely located device upon determining that the buffer data indicates that the at least some of the events of the user input device are generated in response to physical manipulation by the user.

7. The computer readable medium of claim 6 wherein the at least one user input device of the remotely located device includes a keyboard; and
further wherein the one or more events of the user input device include pressing of one or more keys on the keyboard.

8. The computer readable medium of claim 6 wherein the computer instructions are configured to cause the computer to determine that a person is in physical possession of a remotely located device by at least also:
determining that the user is in not physical possession of the remotely located device upon determining that the buffer data indicates that the at least some of the events of the user input device are not generated in response to physical manipulation by the user.

9. The computer readable medium of claim 6 wherein the computer instructions are configured to cause the computer to determine that a person is in physical possession of a remotely located device by at least also:
comparing the user-generated data to predetermined reference data.

10. The computer readable medium of claim 9 wherein the computer instructions are configured to cause the computer to determine that a person is in physical possession of a remotely located device by at least also:
authenticating the user of the remotely located device only upon a condition in which (i) the user-generated data matches the predetermined reference data and (ii) the user is determined to be in physical possession of the remotely located device.

11. A computer system comprising:
at least one processor;
a computer readable medium that is operatively coupled to the processor;
network access circuitry that is operatively coupled to the processor; and
authentication logic (i) that executes at least in part in the processor from the computer readable medium and (ii) that, when executed, causes the processor to determine that a person is in physical possession of a remotely located device by at least:
monitoring the remotely located device for gesture-induced data associated with physical manipulation of at least one user input device of the remotely located device;
causing the remotely located device to record buffer data representing one or more events of the user input device;
causing the remotely located device to record user-generated data received from the user input device;
determining whether the buffer data indicates that the user-generated data is generated in response to physical manipulation by the user; and
determining that the user is in physical possession of the remotely located device upon determining that the buffer data indicates that the at least some of the events of the user input device are generated in response to physical manipulation by the user.

12. The computer system of claim 11 wherein the at least one user input device of the remotely located device includes a keyboard; and
further wherein the one or more events of the user input device include pressing of one or more keys on the keyboard.

13. The computer system of claim 11 wherein the authentication logic causes the computer to determine that a person is in physical possession of a remotely located device by at least also:
determining that the user is in not physical possession of the remotely located device upon determining that the buffer data indicates that the at least some of the events of the user input device are not generated in response to physical manipulation by the user.

14. The computer system of claim 11 wherein the authentication logic causes the computer to determine that a person is in physical possession of a remotely located device by at least also:
comparing the user-generated data to predetermined reference data.

15. The computer system of claim 14 wherein the authentication logic causes the computer to determine that a person is in physical possession of a remotely located device by at least also:
authenticating the user of the remotely located device only upon a condition in which (i) the user-generated data matches the predetermined reference data and (ii) the user is determined to be in physical possession of the remotely located device.
